(19) United States
(12) Patent Application Publication
(10) Pub. No.: US 2014/0032608 A1
(43) Pub. Date: Jan. 30, 2014

(54) DATABASE ADAPTER

(71) Applicant: Gregory P. COMEAU, Longmont, CO (US)

(72) Inventor: Gregory P. COMEAU, Longmont, CO (US)

(21) Appl. No.: 13/561,857

(22) Filed: Jul. 30, 2012

(51) Int. Cl. G06F 17/30

(52) U.S. Cl. 707/802; 707/E17.005

(57) ABSTRACT

A system includes a database adapter. The database adapter is to interface an application to a database that the application is not configured to access. The database lacks support for database global temporary tables. The database adapter is to instantiate, in the database, a database session temporary table based on a call, received by the database adapter, to the database by the application to access a database global temporary table.

### BACKGROUND

Various database management systems have been developed to allow the storage and manipulation of data in computer systems. In general, a database management system, referred to herein as simply a “database,” includes storage and processing logic through which an application may access and manipulate stored data. Thus, a database defines both the structures for storing data and the operations available for manipulating the stored data. Different database implementations provide different storage and data manipulation capabilities.

### BRIEF DESCRIPTION OF THE DRAWINGS

For a detailed description of exemplary embodiments of the invention, reference will now be made to the accompanying drawings in which:

FIGS. 1 and 2 show block diagrams for a system for accessing a database in accordance with principles disclosed herein;

FIG. 3 shows a block diagram for an implementation of a database adapter in accordance with principles disclosed herein; and

FIGS. 4 and 5 show flow diagrams for methods for accessing a database in accordance with principles disclosed herein.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or a direct connection. Thus, if a first component couples to a second component, the connection may be through a direct connection, through an indirect connection via other components and connections. The recitation “based on” is intended to mean “based at least in part on.” Therefore, if X is based on Y, X may be based on Y and any number of other factors. The term “instantiate” means “to create an instance of.”

### DETAILED DESCRIPTION

The following discussion is directed to various implementations of a database adapter for interfacing an application to a database. Although one or more of these implementations may be preferred, the implementations disclosed should not be interpreted, or otherwise used, as limiting the scope of the disclosure, including the claims. In addition, one skilled in the art will understand that the following description has broad application, and the discussion of any implementation is illustrative and is not intended to intimate that the scope of the disclosure, including the claims, is limited to that implementation.

Different databases used in computing systems provide different capabilities for accessing and manipulating the information stored in the database. Consequently, an application program designed for operation with one database may not operate properly with a different database. The Oracle database (Oracle) produced by the Oracle Corporation and the PostgreSQL database (PostgreSQL) are examples of two databases that provide different capabilities. Because each database provides unique features and capabilities, an application program designed for use with Oracle may apply various features and capabilities of Oracle that result in the application being incompatible with PostgreSQL.

The database adapter disclosed herein allows an application designed to operate with a given database to operate properly with a different database that the application is not designed to support. For example, the database adapter disclosed herein resolves various differences between Oracle and PostgreSQL and allows an application program designed to access Oracle to access and manipulate data stored in PostgreSQL. Thus, the database adapter reduces the time and expense associated with adapting an application program to operate with a second database different from a first database that the application is designed to access.

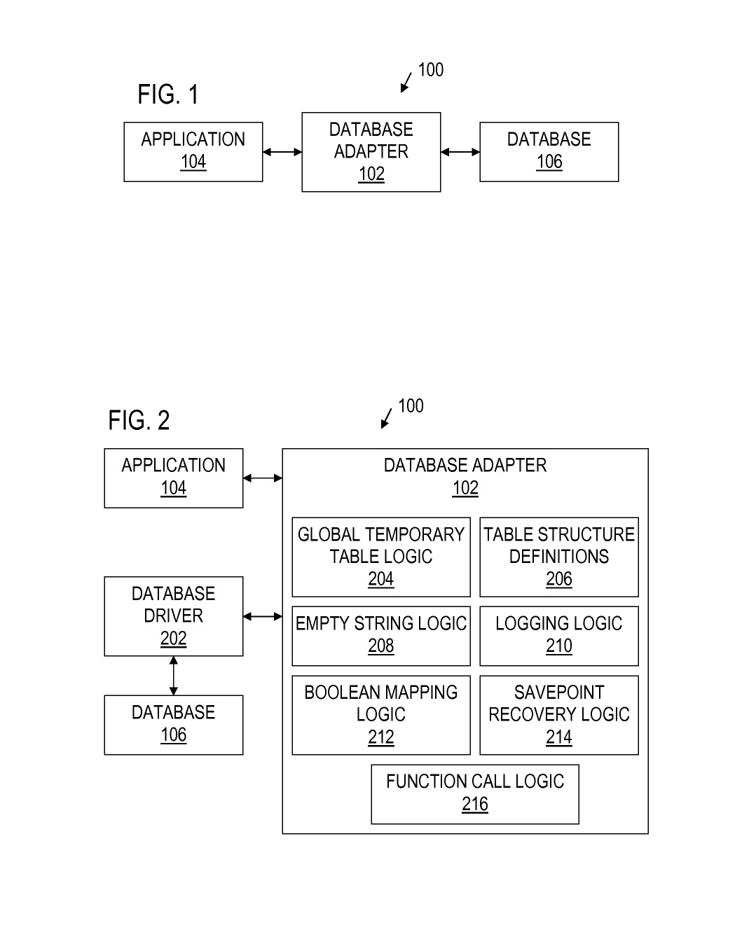

FIGS. 1 and 2 show a block diagrams for a system 100 for accessing a database in accordance with principles disclosed herein. The system 100 includes an application program 104, a database adapter 102, and a database 106. The application program 104 is designed to access a first database, such as Oracle, rather than the database 106. The database 106 may be a PostgreSQL database. The database adapter 102 is disposed between the application 104 and the database 106. The database adapter 102 receives data access and manipulation requests generated by the application 104. The data access and manipulation requests assume that the application is accessing the first database. The database adapter 102 receives the requests and modifies the requests to allow the application 104 to interoperate with the database 106.

In some implementations of the system 100, a database driver 202 is disposed between the database adapter 102 and the database 106. The database driver 202 allows an application program designed to operate with the database 106 to access the database 106. The database driver 202 may be a driver in accordance with the Java Database Connectivity standard (i.e., a JDBC driver) that interfaces a Java application to the database 106. Similarly, the database adapter 102 may present an interface to the application 104 and/or an interface to the database driver 202 that accords with the JDBC standard.

The database adapter 102 includes logic to adapt database operation requests generated by the application 104 to the database 106. The database adapter 102 may include global temporary table logic 204, empty string logic 208, Boolean mapping logic 212, savepoint recovery logic 214, function call logic 216, and/or logging logic 210. In conjunction with the global temporary table logic 204, the database adapter 102 may include table structure definitions 206 that define the structure of global temporary tables that the application 104 is designed to access in the database 106.

A global temporary table is a database table the structure of which is globally defined in the database, and the data of which is private to a session or transaction using the table. In contrast, a session temporary table is a database table the structure and data of which are private to the session using the table. Some databases (e.g., Oracle) support global temporary tables. The database 106 does not support global temporary tables, but rather supports session temporary tables. The application 104 assumes that the database 106 supports global temporary tables and issues calls to the database 106 that access global temporary tables. Such calls are incompatible with the database 106.

The global temporary table logic 204 identifies calls to the database 106 from the application 104 that access a global temporary table. In response to such a call, the global temporary table logic 204 instantiates, in the database 106, a session temporary table having the structure of the requested global temporary table, and thereafter passes the call to the database 106. The structure of the global temporary table is defined in the table structure definitions 206, and retrieved by the global temporary table logic 204 to instantiate the corresponding session temporary table. Thus, the database adapter 102 allows the application 104 to access the database 106 using calls directed to global temporary tables though the database 106 lacks support for global temporary tables.

An empty string is a string of length zero. In contrast, “NULL” indicates a missing or non-existent data item. In some databases (e.g., Oracle), an empty string and NULL are equivalent. The database 106 treats the empty string and NULL as distinct values. The application 104 may treat the empty string and NULL as equivalents assuming that the database 106 so functions. Thus, the application 102 may generate and provide an empty string to the database 106 assuming that the database 106 treats the empty string as NULL.

The empty string logic 208 identifies an empty string written to the database 106 by the application 104, converts the empty string to a NULL indicator, and provides the NULL indicator to the database 106 in place of the empty string. Thus, the database adapter 102 allows the application 104, which treats NULL and empty strings as equivalents, to write an empty string to the database 106 while the database 106 receives a NULL.

In some databases (e.g., Oracle), Boolean values (TRUE and FALSE) may be stored as numeric values (e.g., “1” and “0”) in a numerically typed field. In the database 106, typing is strictly enforced, such that attempting to store a Boolean value in a numerical field or a numeric value in a Boolean field results in an error condition. The application 104 may be designed to write a Boolean value to a numeric field of the database 106.

The Boolean mapping logic 212 identifies a transaction from the application 104 to the database 106 that attempts to access a Boolean value in a numeric field of the database 106. The Boolean mapping logic 212 converts the operation to access a Boolean value in a Boolean field of the database 106, or to access a numeric value to a numeric field. The Boolean mapping logic 212 may apply such conversion to both read and write access of the database 106. Thus, the database adapter 102 allows the application 104 to access Boolean values in the database 106 using transactions that place the Boolean value in a numeric field, while the database 106 lacks support for such transactions.

A database transaction may include a number of requests for database operations. In some databases (e.g., Oracle), if an error occurs in the execution of an operation of a transaction, the transaction is automatically recoverable because the operations executed prior to the error are not discarded. With such a database, the failed operation may be corrected and the transaction completed successfully. The database 106 lacks support for such recovery if an error in an operation of the transaction occurs. The application 104 may expect the database 106 to provide automatic recovery of transaction errors.

The savepoint recovery logic 214 instantiates a savepoint for each database operation initiated by the application 104. A savepoint is a mark within a database transaction that indicates a point to which the transaction can be “rolled back” without discarding operations of the transaction occurring before the savepoint. Some implementations of the savepoint recovery logic 214 may instantiate multiple savepoints per transaction. If an error occurs during execution of a transaction with the database 106 initiated by the application 104, rather than discarding the transaction, the database adapter 102 can recover the transaction by rolling back the transaction to the last savepoint instantiated by the database adapter 102. Thereafter, the failed operation can be corrected and the transaction completed. Thus, the database adapter 102 provides the automatic transaction recovery expected by the application 104 while the database 106 lacks such recovery.

Because capabilities differ across databases, calls used to access one database may not be supported by another database. For example, some databases (e.g., Oracle) support packages, where a package is a set of related database functions stored together in the database for use as a unit. The database 106 may not support packages, and thus, may not support calls of functions of a package (i.e., package function calls). The application 104 may generate package function calls to access data stored in the database 106.

The function call logic 216 recognizes package function calls generated by the application 104. The function call logic 216 replaces the package function call with a non-package function call applicable to the database 106 that invokes functionality of the database 106 corresponding to the functionality the application 104 intended to invoke with the package function call. The function call logic 216 provides the non-package function call to the database 106 in place of the package function call. Thus, the database adapter 102 allows the application 104 to access the database 106 using package function calls that are unsupported by the database 106.

The function call logic 216 also recognizes function calls generated by the application 104 that are not supported by the database 106. The function call logic 216 may discard the calls not supported by the database 106 and return to the application with no indication of an error having occurred. Thus, the database adapter 102 allows the application 104 to generate calls not supported by the database 106 without producing an error that affects application execution.

Some database calls may be unsupported or cause an error in a particular context. For example, databases (e.g., Oracle, PostgreSQL) may provide an autocommit mode that causes the database to commit each executed database operation. Some such databases may accept a commit call issued by an application while in autocommit mode without error. The database 106 does not support commit calls while in autocommit mode, and considers reception of a commit call while in autocommit mode to be an error. The application 104 may issue commit calls while the database 106 is in autocommit mode. The function call logic 216 identifies commit calls issued by the application 104 while the database 106 is in autocommit mode, discards the commit calls, and returns non-error status to the application 104.

The logging logic 210 captures information related to transactions with the database 106 initiated by the application 104. The logging logic 210 provides the captured information to an information recording system that stores the information. The logging logic 210 may capture information relevant to all accesses of the database 106 by the application 104 because all accesses pass through the database adapter 102. Information captured by the logging logic 210 may include database access requests received from the application 104, outputs of the database adapter 102 provided to the database driver 202 and/or the application 104, status generated by the database driver 202, status and request responses provided by the database 106, and timing information (e.g., timestamps) associated with the captured information.

The database adapter 102 includes hardware resources and instructions that perform the operations of the global temporary table logic 204, empty string logic 208, Boolean mapping logic 212, savepoint recovery logic 214, function call logic 216, and/or logging logic 210 disclosed herein. For example, some implementations of the database adapter 102 include one or more processors and storage encoded with instructions executable by the processors to perform the operations disclosed herein.

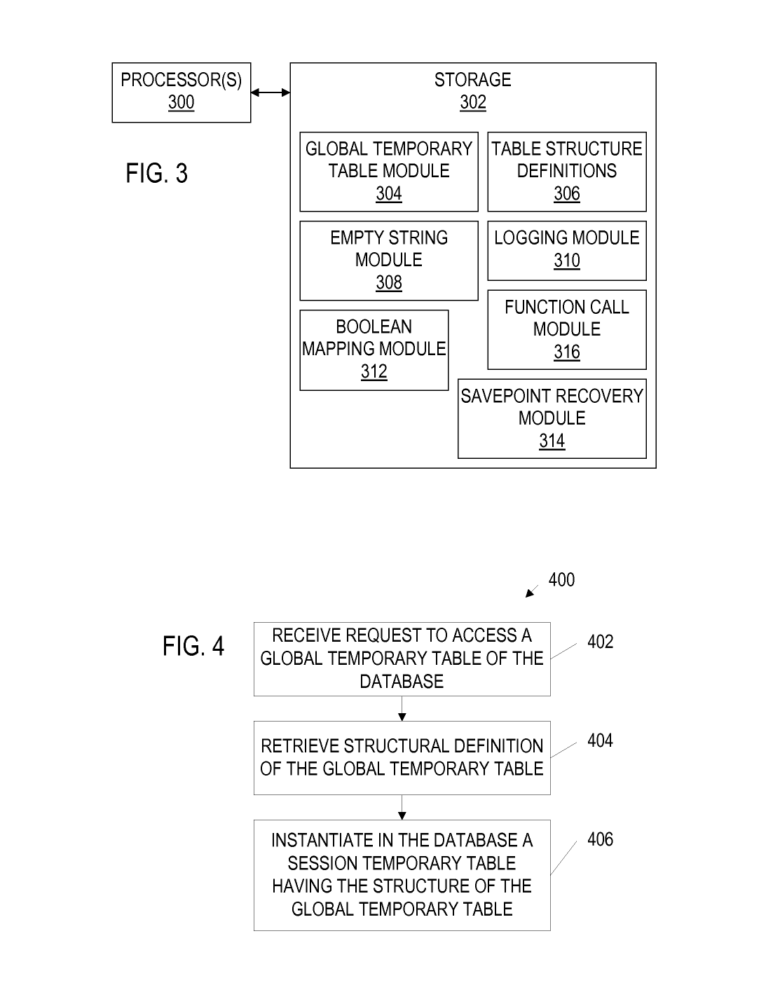

FIG. 3 shows a block diagram for a processor-based implementation of the database adapter 102 in accordance with principles disclosed herein. The processor-based implementation of the database adapter 102 includes processor(s) 300 and storage 302. The processor(s) 300 include, for example, a general-purpose microprocessor, digital signal processor, microcontroller, or other device configured to execute instructions for performing the database adapter operations disclosed herein. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

The storage 302 stores instructions that the processor 300 executes to perform the database adapter functions disclosed herein. The storage 302 is a non-transitory computer-readable storage medium. A computer-readable storage medium may include volatile storage such as random access memory, non-volatile storage (e.g., a hard drive, an optical storage device (e.g., CD or DVD), FLASH storage, read-only-memory), or combinations thereof. Processors execute software instructions. Software instructions alone are incapable of performing a function. Therefore, in the present disclosure, any reference to a function performed by software instructions, or to software instructions performing a function is simply a shorthand means for stating that the function is performed by a processor executing the instructions.

The storage 302 includes a global temporary table module 304 and table structure definitions 306, empty string module 308, Boolean mapping module 312, savepoint recovery module 314, function call module 316, and/or logging module 310. The global temporary table module 304, table structure definitions 306, empty string module 308, Boolean mapping module 312, savepoint recovery module 314, function call module 316, and logging module 310 include instructions (executable by the processor(s) 300) and data (accessible by the processor(s) 300) for implementing the global temporary table logic 204, table structure definitions 206, empty string logic 208, Boolean mapping logic 212, savepoint recovery logic 214, function call logic 216, and logging logic 210 disclosed herein.

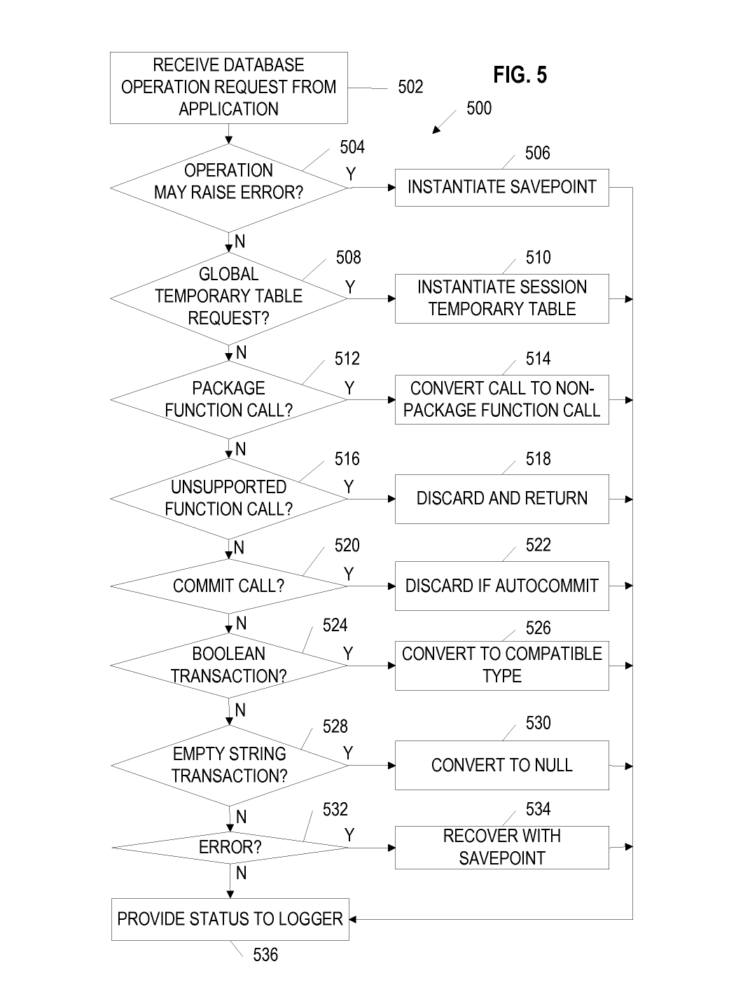

FIG. 4 shows a flow diagram for a method 400 for accessing a database in accordance with principles disclosed herein. Though depicted sequentially as a matter of convenience, at least some of the actions shown can be performed in a different order and/or performed in parallel. Additionally, some implementations may perform only some of the actions shown. At least some of the operations of the method 400 can be performed by a processor (e.g., processor(s) 300) executing instructions read from a computer-readable medium (e.g., storage 302).

In block 402, the database adapter 102 receives a request to access a global temporary table of the database 106. The request is generated by the application 104. The database 106 lacks support for global temporary tables.

In block 404, the database adapter 102 retrieves a structural definition of the global temporary table from a set of stored table structure definitions associated with the database adapter 102.

In block 406, the database adapter 102 instantiates, in the database 106, a session temporary table. The structure of the instantiated session temporary table is based on the structural definition retrieved from the stored table structure definitions. Consequently, the instantiated session temporary table is structurally equivalent to the requested global temporary table. The application 104 accesses the session temporary table in place of the requested global temporary table.

FIG. 5 shows a flow diagram for a method 500 for accessing a database in accordance with principles disclosed herein. Though depicted sequentially as a matter of convenience, at least some of the actions shown can be performed in a different order and/or performed in parallel. Additionally, some implementations may perform only some of the actions shown. At least some of the operations of the method 500 can be performed by a processor (e.g., processor(s) 300) executing instructions read from a computer-readable medium (e.g., storage 302).

In block 502, the database adapter 102 receives a request to access the database 106 from the application 104. The application 104 is designed to access a database other than the database 106. The database 106 lacks support for various functions of the database the application is designed to access.

In block 504, the database adapter 102 determines whether the access requested by the application 104 may raise an error. The database 106 lacks support for automatic recovery of a transaction if an error occurs during the transaction. The application 104 may be designed to expect such automatic recovery. If the requested access is may raise an error, the database adapter 102 instantiates a savepoint in the database 106 in block 506. In some implementations, multiple savepoints may be instantiated corresponding to multiple operations of a transaction as requested by the application 104. Should an error occur, the instantiated savepoint(s) allow the database adapter 102 to recover the transaction by rolling back to the last savepoint.

In block 508, the database adapter 102 determines whether the access requested by the application 104 is to access a global temporary table in the database 106. The database 106 lacks support for global temporary tables. If the request is to access a global temporary table, then the database adapter 102 retrieves a structural definition of the global temporary table from a set of stored table structure definitions associated with the database adapter 102. The database adapter 102 instantiates, in the database 106, a session temporary table in block 510, and passed the request to the database 106. The structure of the instantiated session temporary table is based on the structural definition retrieved from the stored table structure definitions. Consequently, the instantiated session temporary table is structurally equivalent to the requested global temporary table. From the perspective of the application 104, the global temporary table has been instantiated.

In block 512, the database adapter 102 determines whether the access requested by the application 104 is a package function call. The database 106 lacks support for packages and package function calls. If the request is a package function call, then if the database 106 supports a non-package function call invoking database functionality corresponding to that required by the package function call, then in block 514 the database adapter 102 converts the package function call to the corresponding non-package function call. The data adapter 102 discards the package function call and provides the non-package function call to the database 106.

In block 516, the database adapter 102 determines whether the access requested by the application 104 is a call that is unsupported by the database 106. If the request is a call that is not supported by the database 106, then in block 518 the database adapter 102 discards the call and returns to the application 104 status that does not indicate occurrence of an error in execution of the call.

In block 520, the database adapter 102 determines whether the access requested by the application 104 is a commit call. If the request is a commit call, then if the database 106 is in autocommit mode, then the database adapter 102 discards the commit call in block 522 and returns non-error status to the application 104. If the database 106 is not in autocommit mode, then the database adapter 102 passes the commit call to the database 106 for execution.

In block 524, the database adapter 102 determines whether the access requested by the application 104 is an access of a Boolean value in a numerically typed field of the database 106. The database 106 enforces strong typing. Consequently, an access type mismatch will cause an error if executed in the database 106. If the request is an access of a Boolean value in a numerically typed field, then in block 526 the database adapter 102 converts the request to access the Boolean value in a Boolean field, or to access a numeric value in a numerically typed field, and transfers the converted request to the database 106 for execution.

In block 528, the database adapter 102 determines whether the access requested by the application 104 transfers an empty string to the database 106. The database 106 does not treat the empty string and NULL equivalently, while the application 104 is designed to expect equivalency of NULL and the empty string in the database 106. If the request transfers an empty string, then in block 530 the database adapter 102 converts the empty string to a NULL, and transfers the request including the NULL to the database 106.

In block 532, the database adapter 102 determines whether an error has occurred in the execution of an operation of the current transaction. If an error has occurred, then in block 534 the database adapter 102 applies a savepoint instantiated in block 506 to roll back the transaction to the last savepoint instantiated prior to the error. Thus, the database adapter 102 provides automatic recovery of failed transactions.

In block 536, the database adapter 102 captures information concerning each transaction and transfers the information to logging system to be recorded.

The above discussion is meant to be illustrative of the principles and various implementations of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a database adapter to:
interface an application to a database that the application is not configured to access;
instantiate, in the database, a database session temporary table based on a call, received by the database adapter, to the database by the application to access a database global temporary table;
wherein the database lacks support for database global temporary tables.

2. The system of claim 1, wherein the database adapter comprises a definition record that defines structure of the database global temporary table; the database adapter is to retrieve the structure of the database global temporary table from the definition record based on recognition of the call.

3. The system of claim 1, wherein the database adapter is to:
identify package function calls to the database by the application; and
convert the package function calls to non-package function calls executable by the database;
wherein the database lacks support for packages.

4. The system of claim 1, wherein the database adapter is to:
identify calls from the application to the database that are unsupported by the database;
discard the identified calls; and
return to the application without an error indication.

5. The system of claim 1, wherein the database adapter is to:
recognize an operation request to the database that accesses a Boolean variable in a numerically typed field; and
at least one of:
convert the operation to access the Boolean variable in a Boolean typed field of the database; and
convert the operation to access a numerical variable in the numerically typed field of the database.

6. The system of claim 1, wherein the database adapter is to:
instantiate a savepoint for each operation to the database that has potential to cause an error;
apply the savepoint to recover a transaction based on occurrence of an error in the operation.

7. The system of claim 1, wherein the database adapter is to:
identify a commit call to the database by the application; and
discard the commit call based on an automatic commit mode of the database being enabled.

8. The system of claim 1, wherein the database adapter is to:
identify an empty string written to the database by the application; and
provide a NULL value to the database in place of the empty string.

9. The system of claim 1, wherein the database adapter comprises a logger to capture information related to accesses of the database by the application.

10. A method, comprising:
receiving, by a database adapter disposed between a database and an application, a request from the application to access a database global temporary table of the database, wherein the database lacks support for database global temporary tables;
retrieving, by the database adapter, responsive to the request, a structural definition of the database global temporary table from a definition record associated with the database adapter;
instantiating, by the database adapter, in the database, a session temporary table that is structurally equivalent to the database global temporary table.

11. The method of claim 10, further comprising:
at least one of:
identifying, by the database adapter, a package function call to the database from the application, wherein the database lacks support for the package function call;
converting the package function call to a non-package function call, and
providing the non-package function call to the database;
and
identifying, by the database adapter, a call to the database from the application that is unsupported by the database;
discarding the call that is unsupported by the database; and
returning to the application without an error indication.

12. The method of claim 10, further comprising:
at least one of:
instantiating, by the database adapter, a savepoint for each database operation requested by the application that has the potential to cause an error;
applying, by the database adapter, the savepoint to recover a transaction based on occurrence of an error in the operation;
and
identifying, by the database adapter, a commit call to the database by the application; and
discarding the commit call based on an automatic commit mode of the database being enabled.

13. The method of claim 10, further comprising:
at least one of:
recognizing, by the database adapter, an operation request to the database that accesses a Boolean variable in a numerically typed field; and
converting the operation request to access the Boolean variable in a Boolean typed field of the database; or
converting the operation request to access a numerical variable in the numerically typed field of the database;
and
identifying, by the database adapter, an empty string written to the database by the application; and
providing a NULL value to the database in place of the empty string.

14. The method of claim 10, further comprising transferring, by the database adapter, information concerning transactions between the application and the database to a logging system.

15. A non-transitory computer-readable medium encoded with instructions that when executed cause a processor to:
provide a database adapter between a database and an application not configured to access the database; and in providing the database adapter to:
identify a request from an application to access a database global temporary table of the database, wherein the database lacks support for database global temporary tables;
retrieve a structural definition of the database global temporary table from a definition record; and
instantiate, in the database, responsive to the request, a session temporary table that is structurally equivalent to the database global temporary table.

16. The computer-readable medium of claim 15, encoded with instructions that cause the processor, in providing the database adapter, to:
instantiate a savepoint for each database operation request received from the application that has the potential to cause an error; and
apply the savepoint to recover a transaction based on occurrence of an error caused by the operation request.

17. The computer-readable medium of claim 15, encoded with instructions that cause the processor, in providing the database adapter, to:
identify a commit call to the database by the application; and
discard the commit call based on an automatic commit mode of the database being enabled.

18. The computer-readable medium of claim 15, encoded with instructions that cause the processor, in providing the database adapter, to:
identify a package function call to the database from the application, wherein the database lacks support for the package function call;
convert the package function call to a non-package function call, and
provide the non-package function call to the database.

19. The computer-readable medium of claim 15, encoded with instructions that cause the processor, in providing the database adapter, to:
identify a call to the database from the application that is unsupported by the database;
discard the call that is unsupported by the database; and
return to the application without an error indication.

20. The computer-readable medium of claim 15, encoded with instructions that cause the processor, in providing the database adapter, to:
recognize an operation request to the database that accesses a Boolean variable in a numerically typed field; and
convert the operation request to access either the Boolean variable in a Boolean typed field of the database, or a numerical variable in the numerically typed field of the database; and to:
identify an empty string written to the database by the application; and
provide a NULL value to the database in place of the empty string.
